(19) United States
(12) Patent Application Publication
(10) Pub. No.: US 2009/0173165 A1
(43) Pub. Date: Jul. 9, 2009

(54) SENSOR AND DETECTION DEVICE FOR USE OF THE SENSOR

(76) Inventors: Pal Georg BENESTAD, LIERSKOGEN (NO); Harald BENESTAD, LIERSKOGEN (NO)

Correspondence Address: RODMAN RODMAN, 10 STEWART PLACE, SUITE 2CE, WHITE PLAINS, NY, 10603, US

(21) Appl. No.: 12/344,751

(22) Filed: Dec. 29, 2008

(30) Foreign Application Priority Data
Jan. 4, 2008 (NO) NO20080077

(51) Int. Cl. G01F 1/74; H01F 5/00

(52) U.S. Cl. 73/861.04; 29/605

(57) ABSTRACT

A sensor of the inductive type comprising at least one support, wherein the support is provided with at least one coil, and wherein the coil is adapted to be fed with a high-frequency signal. The coil or each coil part thereof has its respective windings arranged in one plane and the support is formed of a disc-shaped substrate having a deformation temperature which is at least 1000° C. The windings are provided on the substrate by vapour deposition or etching. The sensor is adapted for operation selected in the frequency range of 1 MHz-1 GHz. Through the substrate and in the centre of said at least one coil there may be arranged a core of ferromagnetic material. The sensor is expediently embeddable with the aid of glass ceramic material or glass material in an aperture in a holder of metal or metal alloy. The sensor is, for example, useful for multiphase measurement of a fluid flow containing a fraction of water, at a pressure selected in the range of 0-1500 bar and a temperature selected in the range of from −50° C. to +250° C. The sensor is particularly useful in a sensor device in which with the aid of glass ceramic material or glass material there is embedded in at least one aperture in the holder a respective capacitive sensor, the holder via an intermediate piece being connected to an attachment flange designed for mounting on pipeline equipment which carries said fluid, so that the holder when so mounted penetrates into the fluid flow. Thus, said water fraction can be detected capacitively and at least partly inductively in a first measuring range and detected inductively in a second measuring range.

The present invention is related to a sensor of inductive type comprising at least one support, wherein the support is provided with at least one coil, and wherein the coil is adapted to be fed with a high-frequency signal, as disclosed in the preamble of attached claim 1.

Furthermore, the invention is related to a device for the detection of water fraction or “water cut” in a multiphase flow of fluid, wherein the device has a holder of metal or metal alloy having at least one aperture in which with the aid of glass ceramic material or glass material there is embedded a respective capacitive sensor, the holder being connected via an intermediate piece to an attachment flange intended for mounting on pipeline equipment carrying said fluid, so that the holder when so mounted penetrates into the fluid flow, as disclosed in the preamble of attached claim 17

Moreover, the invention is related to a method for multiphase measurement of a fluid flow for detection of water fraction in said fluid, wherein a sensor device is used that projects into or is in contact with the fluid flow, as disclosed in the preamble of attached claim 24.

In addition, the invention is related to a specific use of said sensor and said device.

For measuring multiphase fluid flow, it is previously known to use a water cut meter (WCM) produced by phase TECHNOLOGIES AS in Norway. This meter uses a plurality of capacitive sensors in addition to being able to have both temperature meters and a manometer.

During oil production, that is to say, the recovery of hydrocarbons from subterranean formations either by drilling onshore from the surface or offshore beneath the seabed, a certain fraction of water will as a rule be present in the fluid flow of oil that is produced. As the reservoir is emptied, the fraction of water will gradually increase. Therefore, after some time there comes a point in the production when measures must be taken to help to prevent the percentage of water from increasing significantly in the fluid recovered from the formation, for example, by moving the recovery point or by causing more oil to be forced out at the discharge point. It is however important, not least from a production and profitability point of view, to have a clear picture of the percentage of water at all times, so that necessary decisions can be taken under way when this percentage exceeds a desired value.

Capacitive measurement of such multiphase fluid flow consisting of, for example, oil and water, functions extremely well as long as the water fraction remains below about 50%. When the water fraction rises above this limit value it is difficult, tricky or impossible to be able to determine the water fraction using capacitive meters.

Although the known water cut meters function extremely well in the most common operating conditions, because the water fraction remains below or well below 50%, there has nevertheless arisen a need to be able to determine with certainty the water fraction in the fluid flow when it approaches or has passed 50%. As indicated in FIG. 7, during a period of, for example, 1.5-2 years, the fraction of water in the fluid flow may be insignificant and can be recorded with accuracy by, for example, the said known water cut meter. However, after such a period, the water fraction in some formation reservoirs will rise rapidly, with the result that it may be as much as 90% after three years' production. It is therefore important to find out when measures should be implemented, for example, by moving production or by declaring the borehole no longer profitable to operate.

It has been found that inductive sensors will be capable of measuring water fraction that is about 50% or higher, but also for values that are somewhat lower, for example, down to 30-40%, so that with the aid of one inductive sensor it is also possible at the same time to measure in a transitional phase where the detection capacity of the capacitive sensor gradually diminishes.

For measuring in environments where high fluid pressures and high fluid temperatures prevail, as for example in the recovery of hydrocarbons from formations beneath the seabed, stringent demands are made where operational reliability is concerned, in that such fluid flow meters should be expected to have a lifetime of at least 25 years. By high fluid pressures is meant, for example, pressures of up to about 1500 bar, and by high fluid temperatures is meant temperatures of up to, for example, about +250° C., although such equipment should also be capable of withstanding low temperatures, for example, down to −40° C. without being damaged as a result. It will be understood that fluid flow meters must be capable of withstanding large pressure and temperature fluctuations without leakages occurring in the meter.

In the light of these facts, there emerged in connection with the invention the challenge of providing in the first place a sensor of the type referred to in the introduction, and in the second place a device for measuring fluid flow which includes such a sensor, together with at least one capacitive sensor, so as to be able to extend the measuring range for such a sensor-based device in a reliable manner.

According to the invention, the aforementioned sensor is characterised, as disclosed in claim 1, in that the coil or each coil part thereof has its respective windings arranged in one plane, that the support is formed of a disc-shaped substrate having a deformation temperature which is at least 1000° C., that the windings are provided on the substrate by vapour deposition or etching, and that the coil is adapted for operation selected in the frequency range of 1 MHz-1 GHz.

Additional embodiments of the sensor will be apparent from subsidiary patent claims 2-13.

The sensor will advantageously be used for multiphase measurement of a fluid flow containing a fraction of water, at a pressure selected in the range of 0-1500 bar and a temperature selected in the range of from −50° C. to +250° C., as disclosed in claim 14. Additional aspects of the use can be seen from claims 15 and 16.

The device referred to in the introduction is characterised, according to the invention, in that the holder has at least one additional aperture in which there is embedded a respective sensor of said inductive type, as disclosed in claim 17.

Additional embodiments of the device are set forth in subsidiary claims 18-21.

A preferred use of the device is related to the detection of water fraction in a hydrocarbon-containing fluid flow during recovery of hydrocarbons from a land-based, subterranean formation or from a formation located beneath a seabed, as disclosed in claims 22 and 23.

The aforementioned method, as disclosed in claim 24, is characterised according to the invention in that said water fraction is detected capacitively and at least partly inductively in a first measuring range, and that said condition is detected inductively in a second measuring range.

Additional embodiments of the method are set forth in attached subsidiary claims 25-27.

The invention will now be explained in more detail with reference to the attached drawings which show exemplary embodiments that are non-limiting for the invention.

FIG. 1 is a basic diagram of a sensor device containing an inductive sensor, according to the invention.

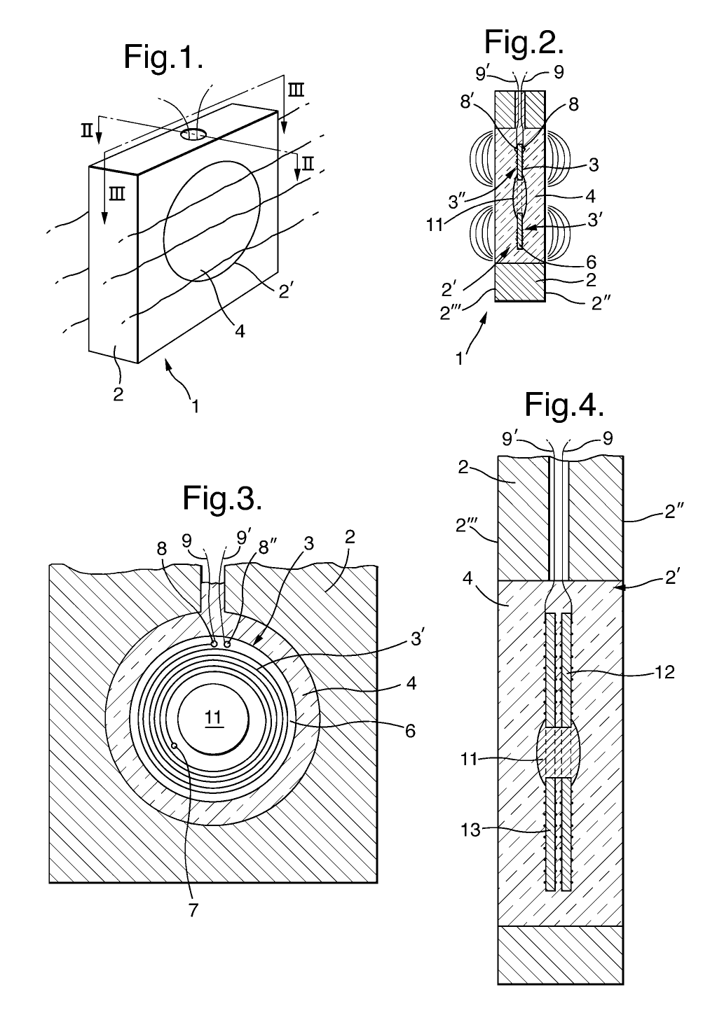

FIG. 2 shows the section II-II in FIG. 1

FIG. 3 shows the section III-III in FIG. 1

FIG. 4 shows a modification of the device shown in FIG. 2.

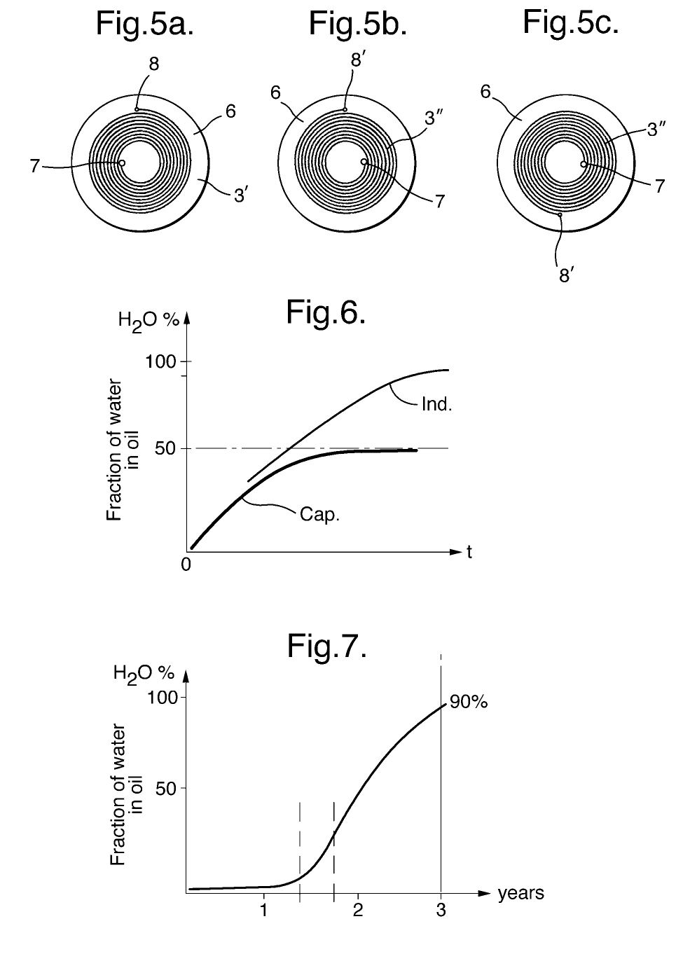

FIG. 5a shows a sensor seen from a first side face, FIG. 5b shows the sensor seen from a second, opposite side face in a first configuration, and FIG. 5c shows the sensor seen from the second side face in a second configuration.

FIG. 6 shows detection properties for respectively a capacitive and an inductive sensor in relation to water fraction in a fluid flow.

FIG. 7 illustrates water fraction in oil-containing fluid in relation to recovery time from a formation reservoir.

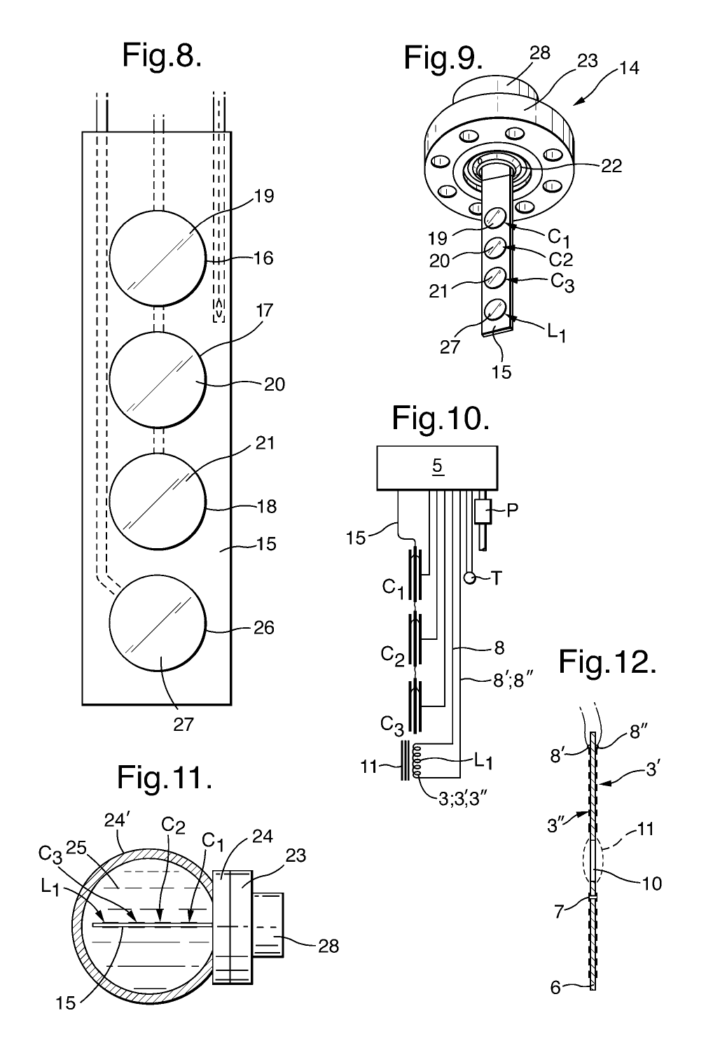

FIG. 8 illustrates part of a sensor device.

FIG. 9 shows a sensor device, according to the invention.

FIG. 10 shows a simplified connection diagram for the sensor device according to FIG. 9.

FIG. 11 shows the sensor device according to FIG. 9 connected to a pipeline for measuring the multiphase fluid flow therein.

FIG. 12 shows a cross-section of a sensor to illustrate through connection.

FIGS. 1-3 show in general a sensor device 1 with a holder 2 of metal or metal alloy. The holder 2 has a through aperture 2′ designed to hold the inductive sensor 3, the sensor being embeddable in the aperture 2′ with the aid of glass ceramic material 4 or glass material, so that the holder 2, together with said material 4, forms a casing for the sensor. In a preferred but by no means limiting embodiment of the invention, the holder is made of a metal alloy that is suitable for the operating conditions for which the invention is intended.

The sensor 3 comprises at least one support 6, said support being provided with at least one coil 3′; 3″. The coil is adapted to be fed with a high-frequency signal selected in the frequency range of 1 MHz-1 GHz, preferably in the range of 10 MHz-500 MHz, from a signal processing unit 5, as shown in FIG. 10.

The coil may have a set of windings arranged in one plane, as shown in FIG. 5a, but the currently preferred embodiment of the invention has one coil consisting of two coil parts 3′, 3″ on opposite sides of a disc-shaped substrate 6 which forms the support. The material of the substrate is electrically insulating and is selected from the group: alumina (Al₂O₃), ceramic material, sapphire and crystallised glass material. The currently preferred material is alumina. On account of the fixing of the sensor 3 in the glass ceramic material or glass material 4, it is important that the substrate is dimensionally stable at high temperatures, not only at the operating temperatures at which the sensor is to operate, and it is a requirement therefore that the substrate should have a deformation temperature that is at least 1000° C.

Each coil part 3′, 3,″ has its respective windings arranged in one plane, and the windings are advantageously formed of copper or copper alloy, and are provided on the substrate by vapour deposition or etching.

Although it should not be understood as limiting for the possible embodiments of the sensor, the coil windings in a preferred embodiment are selected to have a width of about 0.1 mm and a thickness of about 0.004 mm. In this non-limiting example, the disc-shaped substrate 6 is selected to have a thickness of about 0.4 mm and a diameter selected in the range of 10-100 mm. As shown in FIGS. 5a-5c, the number of windings may, for example, be ten. In practice, the number of coil windings will be approximately inversely proportional to selected operating frequency.

When using the configuration shown in FIG. 5a and FIG. 5c, i.e., seen from opposite sides of the substrate, the winding may be series-connected using a lead-in connection 7 in the substrate. To get the connection points 8, 8′ at approximately the same position on the substrate, it will be seen that either the outermost winding must run about 180° more or less, or that the innermost winding, for example, runs about 180° less.

When using the coil winding configuration shown in FIG. 5a and FIG. 5b, the windings in this case will have to be parallel-connected. The said lead-in connection 7 can be utilised also when parallel connection is used, but then with a wire connection to it, in addition to a lead-in connection for connection points 8, 8′, which then become a common point and will have one common wire connection.

As shown in FIGS. 2, 3 and 12, the disc-shaped substrate 6 is equipped with coil windings on both side faces thereof, and the windings of the coil parts 3′, 3″ are in the example connected in series, cf. the explanation given above in connection with FIGS. 5a and 5c, via the lead-in connection 7 in the substrate, so-called “via”. Normally, connection to the coil, which in this case consists of two coil parts 3′, 3″, will be effected at connecting terminals 8; 8′ on opposite sides of the substrate 6, but it will be understood that there could be a further lead-in connection, thereby enabling connection by means of wires 9, 9′ to the sensor 3 to be effected either on opposite sides of the substrate 6 at terminals 8, 8′ or on the same side at terminals 8, 8″, as indicated in FIG. 3.

As indicated in FIGS. 2, 3, 4 and 12, a core 11 of ferromagnetic material may be arranged through a hole 10 in the substrate disc 6 and in the centre of said at least one coil or coil parts 3′, 3″ thereof. This core can advantageously be formed of a thin film material and positioned by an appropriate process.

As indicated in FIG. 4, the sensor may include, for example, at least two supports 12, 13 for forming a layered structure, and the coil windings supported by the supports are interconnected so as to form in reality one coil that is connected to the unit 5 via the wire pair 9, 9′. Optionally, it is conceivable to provide coils connected in parallel.

It will be understood, inter alia, on studying what is shown in FIGS. 1, 2 and 4 that the sensor device is so configured that the material 4 is flush with the side faces 2″, 2′″ of the holder 2, and completely surrounds and electrically insulates the sensor from the medium to be detected, and that the side faces 2″, 2′″ extend parallel to the main flow direction of said fluid.

According to the invention, such a sensor will be especially suitable for multiphase measurement of a fluid flow containing a fraction of water, at a pressure selected in the range of 0-1500 bar and at a temperature selected in the range of from −50° C. to +250° C. The sensor will be particularly useful when the fraction of water in the fluid flow is greater than 30-50% and the sensor is especially useful for detection of water fraction in a fluid during the recovery of hydrocarbons from a subterranean formation, such as in onshore or offshore oil production.

As indicated in the introduction, capacitive meters have a limited measuring range, although such meters are accurate within that range. It is therefore proposed that the present inductive sensor be used in a device 14 for detection of water fraction in a multiphase fluid flow. The device 14 has a holder 15 of metal or metal alloy with at least one aperture 16, 17, 18 in which with the aid of glass ceramic material or glass material 19, 20, 21 there is embedded a respective capacitive sensor, symbolically shown as C₁, C₂, C₃, see FIG. 12 (not shown in FIGS. 8 and 9 as this is known from the water cut meter mentioned in the introduction). It will be seen that the holder 15 functions as a conductor to the respective reference electrode of the capacitors, whilst the sensor electrodes on each side thereof are interconnected in each capacitor and connected by one conductor for each capacitor to the signal processing unit 5. Alternatively, all of the capacitors' sensor electrodes may be connected to one common conductor, which means that in reality the capacitors are connected in parallel.

The holder 15 is connected via intermediate piece 22 to an attachment flange 23 intended for mounting on pipeline equipment 24 (see FIG. 11) which carries said fluid, so that the holder 15, together with its sensors, when so mounted penetrates into the fluid flow 25 in the pipeline 24′. The holder 15 has at least one additional aperture 26 in which there is embedded by means of glass ceramic material or glass material 27 a respective sensor of the inductive type, such as described in detail above. The inductive sensor L₁ is also not visible in FIG. 8 or 9, but is indicated symbolically in FIG. 10. It will be embedded in the glass ceramic material or glass material as shown and explained in connection with FIGS. 1, 2, 3 and 4. At least one extra sensor selected from the group temperature sensor T and pressure sensor P is mounted on the intermediate piece 22 or the holder 15.

Said at least one capacitive sensor C₁, C₂, C₃ and said at least one inductive sensor L₁ are connectable to the common signal processing equipment represented by the unit 5. In addition, said at least one extra sensor T; P may be connected to said common signal processing equipment in the form of the unit 5. This equipment is placed in a pressure-resistant housing 28 on said attachment flange 23. The pressure-resistant housing will, in a preferred embodiment, be designed to withstand a pressure of up to about 700-1500 bar.

It will be understood from the above description that such a device which has both capacitive and inductive sensors, in addition to optional pressure sensor and/or temperature sensor, is particularly suitable for detection of water fraction in a hydrocarbon-containing fluid flow during the recovery of hydrocarbons from a land-based, subterranean formation or from a formation located beneath a seabed, and where the pressure in the fluid flow may be in the range of 0-1500 bar and temperatures selected in the range of from −50° C. to +250° C.

As shown in FIG. 11, a sensor device C₁, C₂, C₃, L₁; 15 is used in multiphase measurement of a fluid flow, for detection of water fraction in said fluid, which device projects into or is in contact with the fluid flow 25, where the glass ceramic material or glass material 19, 20, 21, 27 is flush with the surface of the holder 15 on both side faces thereof, and where both side faces are parallel to the main flow direction of said fluid.

In a first measuring range, i.e., where the water fraction is equal to or less than about 50%, the water fraction is detected capacitively and at least more than part of the range inductively as indicated in FIG. 6, whilst the water fraction is detected inductively in a second measuring range when the water fraction is equal to or greater than about 50%. As mentioned above, said fluid will contain oil and water which has been produced during the recovery of hydrocarbons from a land-based, subterranean formation or from a formation located beneath a seabed.

1. A sensor of inductive type comprising at least one support, wherein the support is provided with at least one coil, and wherein the coil is adapted to be fed with a high-frequency signal, characterised in
that the coil or each coil part thereof has its respective windings arranged in one plane;
that the support is formed of a disc-shaped substrate having a deformation temperature which is at least 1000° C.;
that the windings are provided on the substrate by vapour deposition or etching; and
that the coil is adapted for operation selected in the frequency range of 1 MHz-1 GHz.

2. A sensor as disclosed in claim 1, characterised in
that the material of the substrate is electrically insulating and is selected from the group: alumina (Al₂O₃), ceramic material, sapphire and crystallised glass material.

3. A sensor as disclosed in claim 1, characterised in
that the frequency range is 10 MHz-500 MHz

4. A sensor as disclosed in claim 1, characterised in
that the windings are formed of copper or copper alloy.

5. A sensor as disclosed in claim 1, characterised in
that the windings of the coil have a width of about 0.1 mm and thickness of about 0.004 mm; and
that the substrate has a thickness of about 0.4 mm and a diameter selected in the range of 10-100 mm.

6. A sensor as disclosed in claim 1, characterised in
that the substrate is equipped with coil windings on both side faces thereof; and
that the windings either are connected in series via a lead-in connection in the disc, so-called “via”, or are connected in parallel, optionally with the use of a lead-in connection in the substrate.

7. A sensor as disclosed in claim 1, characterised in
that through said substrate and in the centre of said at least one coil there is arranged a core of ferromagnetic material.

8. A sensor as disclosed in claim 7, characterised in
that the core is formed of a thin-film material.

9. A sensor as disclosed in claim 1, characterised in
that the number of coil windings is approximately inversely proportional to selected operating frequency.

10. A sensor as disclosed in claim 1, characterised in
that included in the sensor are at least two supports for forming a layered structure; and
that the coil windings supported by the supports are interconnected.

11. A sensor as disclosed in claim 1, characterised in
that the sensor is connectable to signal processing equipment by means of only two wires.

12. A sensor as disclosed in claim 1, characterised in
that it is embeddable with the aid of glass ceramic material or glass material in an aperture in a holder of metal or metal alloy.

13. A sensor as disclosed in claim 12, characterised in
that the holder is made of a metal alloy.

14. Use of a sensor as disclosed in claim 1 for multiphase measurement of a fluid flow containing a fraction of water, at a pressure selected in the range of 0-1500 bar and a temperature selected in the range of from −50° C. to +250° C.

15. A use as disclosed in claim 14, wherein the fraction of water in the fluid flow is greater than 30-50%.

16. A use as disclosed in claim 14, wherein the fluid flow contains hydrocarbons.

17. A device for the detection of the water fraction in a multiphase fluid flow, wherein the device has a holder of metal or metal alloy having at least one aperture in which with the aid of glass ceramic material or glass material there is embedded a respective capacitive sensor, the holder being connected via an intermediate piece to an attachment flange intended for mounting on pipeline equipment carrying said fluid, so that the holder when so mounted penetrates into the fluid flow, characterised in
that the holder has at least one additional aperture in which there is embedded a respective sensor of inductive type as disclosed in claim 1.

18. A device as disclosed in claim 17, characterised in
that on the intermediate piece or the holder there is mounted at least one extra sensor selected from the group: temperature sensor and pressure sensor.

19. A device as disclosed in claim 17, characterised in
that said at least one capacitive sensor and said at least one inductive sensor are connectable to common signal processing equipment.

20. A device as disclosed in claim 17, characterised in
that said at least one capacitive sensor, said at least one inductive sensor and said at least one extra sensor are connectable to common signal processing equipment.

21. A device as disclosed in claim 19, characterised in
that the common signal processing equipment is located in a pressure-resistant housing on said attachment flange.

22. Use of the device as disclosed in claim 17, for detection of water fraction in a hydrocarbon-containing fluid flow during recovery of hydrocarbons from a land-based, subterranean formation or from a formation located beneath a seabed.

23. A use as disclosed in claim 22 for multiphase measurement of a fluid flow containing a fraction of water, at a pressure selected in the range of 0-1500 bar and a temperature selected in the range of from −50° C. to +250° C.

24. A method for multiphase measurement of a flow of fluid for detection of water fraction in said fluid, wherein a sensor device is used that projects into or is in contact with the fluid flow, characterised in
that said water fraction is detected capacitively and at least partly inductively in a first measuring range; and
that said water fraction is detected inductively in a second measuring range.

25. A method as disclosed in claim 24, characterised in
that in the first measuring range the water fraction in said fluid is equal to or less than 50%; and
that in the second measuring range the water fraction is equal to or greater than 50%.

26. A method as disclosed in claim 24, characterised in
that said fluid contains oil and water produced during the recovery of hydrocarbons from a land-based, subterranean formation or from a formation located beneath a seabed.

27. A method as disclosed in claim 24, characterised in
that during detection the pressure in the fluid flow is in the range of 0-1500 bar; and
that the temperature of said fluid is in the range of from about −50° C. to about +250° C.
